(19) United States
(12) Patent Application Publication
(10) Pub. No.: US 2010/0055599 A1
(43) Pub. Date: Mar. 4, 2010

(54) METHOD OF PREPARING TONER HAVING CORE-SHELL STRUCTURE AND TONER PREPARED USING THE SAME

(75) Inventors: Woo Young Yang, Daejeon-City (KR); Keon li Kim, Daejeon-City (KR); Dae Ii Hwang, Daejeon-City (KR); Jae Bum Park, Daejeon-City (KR); Ii Sun Hwang, Daejeon-City (KR); Jun Hee Lee, Daejeon-City (KR); Jae Kwang Hwang, Daejeon-City (KR); Dong Won Kim, Daejeon-City (KR); Duck Kyun Ahn, Daejeon-City (KR)

Correspondence Address: Nixon Peabody LLP, P.O. Box 60610, Palo Alto, CA, 94306, US

(73) Assignee: SAMSUNG FINE CHEMICALS CO., LTD, ULSAN-CITY (KR)

(21) Appl. No.: 12/528,318

(22) PCT Filed: Feb. 20, 2008
(86) PCT No.: PCT/KR08/00979

§ 371 Date: Aug. 21, 2009

(30) Foreign Application Priority Data
Feb. 23, 2007 (KR) 10-2007-0018502

(51) Int. Cl. G03G 9/08

(52) U.S. Cl. 430/110.2; 430/137.13

(57) ABSTRACT

A method of preparing a toner having a core-shell structure. The method includes: preparing a mixture by mixing a resin with acid groups, a coloring agent and at least one additive with an organic solvent, and neutralizing the acid groups of the resin with a base; forming a micro-suspension solution by adding the mixture to a dispersion medium; forming a toner core by removing the organic solvent from the micro-suspension; and forming a toner complex having a core-shell structure by seed-polymerizing at least one monomer on the surface of the toner core. Thus, the toner that can prevent hot offsets, improve storage stability at a high temperature and improve charge stability against environment changes can be prepared with reduced costs according to the method.

### CROSS-REFERENCE TO RELATED PATENT APPLICATION

This application is a national phase of International Application No. PCT/KR2008/000979, entitled “METHOD OF PREPARING TONER HAVING CORE-SHELL STRUCTURE AND TONER PREPARED USING THE SAME”, which was filed on Feb. 20, 2008, and which claims priority of Korean Patent Application No. 10-2007-0018502, filed on Feb. 23, 2007 in the Korean Intellectual Property Office, the disclosure of which is incorporated herein in its entirety by reference.

### BACKGROUND OF THE INVENTION

1. Technical Field

The present invention relates to a method of preparing a toner having a core-shell structure and a toner prepared using the same, and more particularly, to a method of preparing a toner having a core-shell structure that reduces manufacturing costs, prevents hot offset, and improves storage stability at a high temperature and charge stability against environment changes, and a toner prepared using the method.

2. Background Art

Recently, a need for toner suitable for a high-speed printing, particularly toner capable of improving image quality and preventing hot offset increases in the printing industry. The “hot offset” is a phenomenon in which some of melted toner on a printing paper adheres to a fixing device after passing through the fixing device since too much toner exceeding the amount required to be fixed on the printing paper is excessively melted when the toner is heated while passing through the fixing device.

Generally, a toner is prepared by adding a coloring agent, a charge control agent, a dye, a pigment, a releasing agent, or the like to a thermoplastic resin acting as a binder resin. In addition, inorganic metal fine particles such as silica or a titanium oxide may be added to toner as external additives in order to provide toner with fluidity or improve physical properties such as charge controlling properties or cleaning properties.

Generally, a polyester resin and a styrene-acrylic resin are used as a binder resin. Upon comparing those two resins, the polyester resin has better anti-hot offset properties and color forming/development properties but poorer stability of charged amount according to environment changes compared to the styrene-acrylic resin. Meanwhile, the styrene-acrylic resin has lower hygroscopic properties and better storage stability at a high temperature than the polyester resin.

As described above, a toner needs to have anti-hot offset properties and storage stability, which are contrary to each other, at a high temperature.

U.S. Pat. No. 5,604,076 discloses a toner having a toner-shell structure that can have anti-hot offset properties and storage stability at a high temperature. A resin dispersion is prepared by dispersing a polyester resin in an anionic surfactant. A styrene monomer, an acrylic monomer and a polymerization initiator are added to the resin dispersion and seed-polymerization is performed to form a micro-suspension of toner particles having a polyester resin core/styrene-acrylic resin shell structure. Then, a separate pigment water-dispersion is added to the micro-suspension and the mixture is aggregated to prepare a toner having a core-shell structure. Here, the pigment water-dispersion is prepared by dispersing a pigment in a cathionic surfactant. However, since the pigment is inevitably exposed on the surface of the toner according to the method by adding the separate pigment dispersion to the micro-suspension and aggregating the mixture, charge properties may be deteriorated. Furthermore, the manufacturing process may become complex since the resin dispersion and pigment dispersion are respectively prepared for the preparation of the toner particles.

### DISCLOSURE OF THE INVENTION

The present invention provides a method of preparing a toner with reduced costs and a toner prepared using the method.

The present invention also provides a method of preparing a toner that can prevent hot offsets and a toner prepared using the method.

The present invention also provides a method of preparing a toner that can improve storage stability at a high temperature and a toner prepared using the method.

The present invention also provides a method of preparing a toner that can improve charge stability against environment changes and a toner prepared using the method.

The present invention also provides an electrophotographic image forming device using the toner.

According to an aspect of the present invention, there is provided a method of preparing a toner, the method comprising:
preparing a mixture by mixing a resin with acid groups, a coloring agent and at least one additive with an organic solvent, and neutralizing the acid groups of the resin with a base;
forming a micro-suspension by adding the mixture to a dispersion medium;
forming a toner core by removing the organic solvent from the micro-suspension; and
forming a toner composite by adding at least one monomer and a polymerization initiator to the toner core and seed-polymerizing the resultant using the toner core as a polymerization seed.

The resin with acid groups may be a polyester resin having a number average molecular weight of 2,000-10,000, a poly dispersity index (PDI) of 2-15, a THF insoluble content of 1 wt % or less, an acid value of 5-100 mg KOH/g.

An acid value of the polyester resin may be 7-30 mgKOH/g.

The coloring agent may be in the form of a coloring pigment master batch wherein the amount of the coloring pigment in the master batch is in the range of 10 to 60 parts by weight based on 100 parts by weight of the master batch.

The method may further comprise: aggregating the seed-polymerized toner composite; melt-adhering the aggregated toner composite; and forming toner particles by washing and drying the melt-adhered toner composite, after forming the toner composite.

The resin with acid groups may comprise at least one acid group selected from the group consisting of a carboxyl group, a phosphoric acid group and a sulfonic acid group.

The additive may comprise a charge control agent or a releasing agent.

The dispersion medium may comprise a polar solvent, a surfactant, a thickener, or a mixture thereof.

The monomer used in the seed-polymerization may comprise at least one selected from the group consisting of styrene, n-butyl methacrylate, methacrylic acid, acrylic acid, divinyl benzene and methacrylate.

A polymerization initiator used in the seed-polymerization may comprise at least one selected from the group consisting of potassium persulfate, ammonium persulfate, benzoyl peroxide, lauryl peroxide, sodium persulfate, hydrogen peroxide, t-butyl hydroperoxide, cumene hydroperoxide, p-methane peroxy salt and peroxy carbonate.

According to another aspect of the present invention, there is provided a toner prepared according to the method and having a volume average particle size of 2.0-10.0 μm, a 80% span value of 0.9 or less and a shape factor of 0.6-1.0.

According to another aspect of the present invention, there is provided an electrophotographic image forming device using the toner.

### BEST MODE FOR CARRYING OUT THE INVENTION

Hereinafter, the present invention will now be described more specifically with reference to exemplary embodiments of the invention.

Toner particles prepared according to a method of an embodiment of the present invention include a toner core and a shell.

The toner core which includes a resin with acid groups, a coloring agent and at least one additive is prepared in the form of being dispersed in a dispersion medium, and the shell is formed by adding at least one monomer and a polymerization initiator to the toner core dispersed in the dispersion medium and seed-polymerizing the resultant using the toner core as a polymerization seed.
First, a resin with acid groups is described.

The acid groups are introduced to the resin by chemical bonding. Such acid group which can be neutralized by a base becomes an anion in an aqueous solution and gives hydrophilic properties. Accordingly, the resin with acid groups can be dispersed and stabilized in the particulate form within an aqueous solution. The acid group may be at least one selected from the group consisting of a carboxyl group, a phosphoric acid group and a sulfonic acid group.

The resin with acid groups may include a polyester resin which is suitable for dispersion of a coloring agent and has good fixing properties(fixability) at a low temperature. The polyester resin may be prepared by including a monomer compound having an acid group which can be neutralized as an essential ingredient, and examples of the polyester resin are a carboxyl group-containing polyester resin, a sulfonic acid group(such as dimethyl 5-sulfoisophthalate sodium salt)-containing polyester resin, or a phosphoric acid-containing polyester resin. Among these, the carboxyl group-containing polyester-based resin is preferable, in which a number average molecular weight may be 2,000-10,000, a poly dispersity index (PDI) may be 2-15, a THF insoluble content may be 1 wt % or less, a glass transition temperature may be 45-75° C., a softening temperature (Ts) may be 130-190, and an acid value may be 5-100 mg KOH/g. When the number average molecular weight is less than 2,000, the melt viscosity becomes too low and the range of fixing temperature becomes narrow. On the other hand, when the number average molecular weight is greater than 10,000, large particles are formed while forming particles, and particle size distribution is widened. Furthermore, when the PDI is less than 2, the range of fixing temperature becomes narrow. On the other hand, when the PDI is greater than 15, it becomes difficult to obtain a resin having THF insoluble content of less than 1 wt %. When the THF insoluble content is greater than 1 wt %, it is difficult to prepare micro-suspended particles. Moreover, when the acid value is lower than 5 mg KOH/g, the toner micro-suspension which will be described later may not be easily prepared. On the other hand, when the acid value is greater than 100 mg KOH/g, environmental stability of the prepared toner may be significantly decreased. More preferably, the acid value is 7-30 mg KOH/g.

Here, the polyester resin may be prepared by condensation-polymerization in which polyhydric alcohol components and polybasic carboxylic acid components are mixed and heated, optionally, under reduced pressure and/or in the presence of a catalyst. Examples of the polyhydric alcohol components are polyoxyethylene-(2.0)-2,2-bis(4-hydroxyphenyl)propane, polyoxypropylene-(2.0)-2,2-bis(4-hydroxyphenyl)propane, polyoxypropylene-(2.2)-polyoxyethylene-(2.0)-2,2-bis(4-hydroxyphenyl)propane, polyoxyethylene-(2.3)-2,2-bis(4-hydroxyphenyl)propane, polyoxypropylene-(6)-2,2-bis(4-hydroxyphenyl)propane, polyoxypropylene-(2.3)-2,2-bis(4-hydroxyphenyl)propane, polyoxypropylene-(2.4)-2,2-bis(4-hydroxyphenyl)propane, polyoxypropylene-(3.3)-2,2-bis(4-hydroxyphenyl)propane, polyoxyethylene-(6)-2,2-bis(4-hydroxyphenyl)propane, ethylene glycol, 1,3-propylene glycol, 1,2-propylene glycol, 1,4-butylene glycol, 1,3-butylene glycol, and glycerol. Examples of the polybasic carboxylic acid components are an aromatic or aliphatic polybasic acid and/or an alkyl ester thereof those are commonly used in the preparation of the polyester resin. Examples of the polybasic acid are terephthalic acid, isophthalic acid, trimellitic acid, pyromellitic acid, 1,2,4-cyclohexane tricarboxylic acid, 2,5,7-naphthalene tricarboxylic acid, 1,2,4-naphthalene tricarboxylic acid, 1,2,5-hexane tricarboxylic acid, 1,2,7,8-octane tetracarboxylic acid, and/or alkyl esters of these carboxylic acids, wherein the alkyl group may be a methyl group, an ethyl group, a propyl group and a butyl group. The polybasic acid and/or alkyl esters thereof may be used alone or in a combination of at least two of them.

The content of the resin with acid groups may be in the range of 50 to 98 parts by weight based on 100 parts by weight of the total toner core. When the content is less than 50 parts by weight, the resin is insufficient for binding the components of the toner core. On the other hand, when the content is higher than 98 parts by weight, the amount of the toner core except for the resin is too small to preserve the function of the toner. Here, the toner core includes a coloring agent and an additive which will be described later in addition to the resin with acid groups.

Meanwhile, the coloring agent is not used in the form of the coloring pigment itself, but in the form of a coloring pigment master match in which the coloring pigment is dispersed in a resin. The coloring pigment master batch indicates a resin composition in which a coloring pigment is uniformly dispersed. The coloring pigment master batch is prepared by blending a coloring pigment and a resin at a high temperature and high pressure, or by adding a coloring pigment to a resin solution and applying a high shearing force to disperse the coloring pigment. By using the coloring pigment master batch, a uniform micro-suspension can be prepared by suppressing the exposure of a pigment in the preparation of toner micro-suspension. In the coloring pigment master batch used in an embodiment of the present invention, the amount of the coloring pigment may be in the range of 10-60 parts by weight, preferably 20-40 parts by weight based on 100 parts by weight of the coloring pigment master batch. When the amount of the coloring pigment is less than 10 parts by weight, a desired color may not be reproduced due to too low amount of the pigment of the toner. On the other hand, when the pigment is greater than 60 parts by weight, the pigment dispersion may not be uniform within the coloring pigment master batch.

The coloring pigment may be selected appropriately from pigments commonly and commercially used such as a black pigment, a cyan pigment, a magenta pigment, a yellow pigment and a mixture thereof.

Examples of the pigments are as follows. That is, a titanium oxide or carbon black may be used as the black pigment. A copper phthalocyanine compound and derivatives thereof, an anthraquine compound or a base dye lake compound can be used for the cyan pigment. In particular, a C.I. pigment blue 1, 7, 15, 15:1, 15:2, 15:3, 15:4, 60, 62, 66, or the like can be used. A condensation nitrogen compound, an anthraquine, a quinacridone compound, a base dye lake compound, a naphthol compound, a benzo imidazole compound, a thioindigo compound, or a perylene compound can be used for the magenta pigment. Particularly, C.I. pigment red 2, 3, 5, 6, 7, 23, 48:2, 48:3, 48:4, 57:1, 81:1, 144, 146, 166, 169, 177, 184, 185, 202, 206, 220, 221, 254, or the like can be used. A condensation nitrogen compound, an isoindolinone compound, an anthraquine compound, an azo metal complex, or an allyl imide compound can be used for the yellow pigment. Particularly, C.I. pigment yellow 12, 13, 14, 17, 62, 74, 83, 93, 94, 95, 109, 110, 111, 128, 129, 147, 168, or the like can be used.

The amount of the coloring agent may be an amount sufficient to color the toner and form a visible image by development, and preferably in the range of 3 to 15 parts by weight based on 100 parts by weight of the resin with acid groups. When the amount of the coloring agent is less than 3 parts by weight, coloring effect is not sufficient. On the other hand, when the amount of the coloring agent is greater than 15 parts by weight, sufficient frictional charge amount cannot be obtained due to low electrical resistance, thereby causing contamination.

Meanwhile, the additive includes a charge control agent, a releasing agent or a mixture thereof. [00371 The charge control agent may be a negative-charging charge control agent and a positive-charging charge control agent. Examples of the negative-charging charge control agent are an organic metal complex or a chelate compound such as azo complex containing a chromium or a mono azo metal complex; a salicylic acid compound containing metal such as chromium, iron and zinc; and an organic metal complex of an aromatic hydroxycarboxylic acid and an aromatic dicarboxylic acid, and any known negative-charging charge control agent may be used without limitation. Examples of the positive-charging charge control agent are Nigrosine and modified products of Nigrosine modified with a fatty acid metal salt; and an onium salt including a quaternary ammonium salt such as tributylbenzylammonium 1-hydroxy-4-naphthosulfonate and tetrabutylammonium tetrafluoroborate. These positive/negative-charging charge control agents may be used alone or in combination of at least two. Since the charge control agent stably and quickly charge toner by its electrostatic force, the toner can be stably supported on a developing roller.

The amount of the charge control agent included in the toner may generally be in the range of 0.1 to 10 parts by weight based on 100 parts by weight of the toner core. When the amount of the charge control agent is less than 0.1 parts by weight, toner charge speed is too low and the amount of charging is too low to function as a charge control agent. On the other hand, when the amount of the charge control agent is greater than 10 parts by weight, an overcharge may distort images.

The releasing agent may enhance the fixing properties of the toner image, and examples of the releasing agent are polyalkylene wax such as low molecular weight polypropylene and low molecular weight polyethylene, ester wax, carnauba wax and paraffin wax. The amount of the releasing agent included in the toner may be in the range of 0.1 to 30 parts by weight based on 100 parts by weight of the toner core. When the amount of the releasing agent is less than 0.1 parts by weight, oilless fixing of toner particles in which toner particles are fixed without using oil cannot be achieved. On the other hand, when the amount of the releasing agent is greater than 30 parts by weight, toner may be flocculated while it is stored.

In addition, the additive may further include a long chain fatty acid, or the like. The long chain fatty acid may be appropriately used in order to prevent deterioration of developing properties and obtain high quality images.

The additive may further include external additives. The external additive may be used to improve fluidity of toner or control charge properties, and examples of the external additive are large particulate silica, small particulate silica and polymer beads.

The monomer for polymerization forms a shell surrounding the toner core including the resin with acid groups, the coloring agent and the additives. The monomer is added to the toner core with a polymerization initiator and seed-polymerized to form a shell. Examples of the monomer are styrene, n-butyl methacrylate, methacrylic acid, acrylic acid, divinyl benzene, methacrylate and a mixture thereof. The amount of the monomer in the toner may be in the range of 10 to 200 parts by weight based on 100 parts by weight of the toner core. When the amount of the monomer is less than 10 parts by weight, the entire surface of the toner core cannot be coated by the monomer, and thus storage properties at a high temperature may be not obtained. On the other hand, when the amount of the monomer is greater than 200 parts by weight, the releasing agent, or the like cannot be easily leak out from the toner core during the fixing since the shell is too thick, thereby decreasing fixing properties.

In addition, the polymerization initiator may be potassium persulfate, ammonium persulfate, benzoyl peroxide, lauryl peroxide, sodium persulfate, hydrogen peroxide, t-butyl hydroperoxide, cumene hydroperoxide, p-methane peroxy salt, peroxy carbonate, and a mixture thereof. The amount of the polymerization initiator may be in the range of 0.1 to 5 parts by weight based on 100 parts by weight of the monomer. When the amount of the polymerization initiator is less than 0.1 parts by weight, polymerization may not be properly performed. On the other hand, when the amount of the polymerization initiator is greater than 5 parts by weight, polymerization may not be easily controlled due to rapid reaction.

Hereinafter, a method of preparing a toner according to an embodiment of the present invention will be described.

First, a resin with acid groups, a coloring pigment master batch and at least one additive are mixed with an organic solvent at a temperature of 40 to 95. Then, the acid group is neutralized with a base to prepare a mixture.

Then, the mixture is added to a dispersion medium including a polar solvent, a surfactant and optionally a thickener at 60-98 and stirred to form a micro-suspension.

Then, the micro-suspension is stirred at 60-98, and the organic solvent is removed by evaporation to form a toner core which is dispersed in the dispersion medium.

Then, at least one monomer and a polymerization initiator are added to the toner core and the resultant is seed-polymerized using the toner core as a polymerization seed. A styrene-acrylic resin shell surrounding the toner core formed of polyester resin is formed by the seed-polymerization.

Then, an aggregating agent is added to the formed toner composite and the temperature, pH, and the like are controlled to aggregate the resultant. Here, the aggregated toner composite has a low rigidity and the shape thereof is very irregular.

Then, the aggregated toner composite is melt-adhered to obtain a toner composite having a desired particle size. By such a melt-adhesion, the rigidity of the toner composite is strengthened, and the shape becomes regular. In addition, the shape of the toner composite may change in various shapes from contorted sphere to complete sphere according to the degree of the melt-adhesion.

Finally, the melt-adhered toner composite is cooled, washed and dried to obtain toner particles.

The organic solvent used in the preparation is volatile, has a lower boiling point than polar solvents, and does not mix with polar solvents, and may include at least one type selected from the group consisting of esters such as methyl acetate or ethyl acetate; ketones such as acetone or methylethyl ketone; hydrocarbons such as dichloromethane or tricholoroethane; and an aromatic hydrocarbons such as benzene.

The polar solvent may be at least one selected from the group consisting of water, glycerol, ethanol, ethylene glycol, propylene glycol, diethylene glycol and dipropylene glycol, sorbitol, and preferably water.

The thickener may be polyvinyl pyrrolidone, polyvinyl alcohol, polyacrylic acid, gelatin, chitosan and sodium alginate.

The surfactant may include at least one selected from the group consisting of a nonionic surfactant, an anionic surfactant, a cationic surfactant and an amphoteric surfactant.

Examples of the nonionic surfactant are polyvinyl alcohol, polyacrylic acid, methycellulose, ethylcellulose, propylcellulose, hydroxylethylcellulose, carboxymethylcellulose, polyoxyethylene cetyl ether, polyoxyethylene lauryl ether, polyoxyethylene octylphenyl ether, polyoxyethylene octylphenyl ether, polyoxyethylene stearyl ether, polyoxyethylene norylphenyl ether, ethoxylate, phosphate norylphenols, triton, and dialkylphenoxypoly(ethyleneoxy)ethanol. Examples of the anionic surfactant are sodium dodecyl sulfate, sodium dodecyl benezene sulfonate, sodium dodecyl naphthalene sulfate, dialkyl benzenealkyl sulfate, and sulfonate. Examples of the cationic surfactant are alkyl benzene dimethyl ammonium chloride, alkyl trimethyl ammonium chloride, and distearyl ammonium chloride. Examples of the amphoteric surfactant are amino acid amphoteric surfactant, betaine amphoteric surfactant, lecitin, taurin, cocoamidopropylbetaine, and disodium cocoamphodiacetate. The surfactants described above may be used alone or in combination of at least two.

The base used to neutralize the acid groups, that is, a neutralizer, may be, for example, an alkaline compound such as sodium hydroxide and lithium hydroxide; a carbonate of an alkaline metal such as sodium, potassium and lithium; an alkaline metal acetate; and an alkanolamine such as ammonium hydroxide, methylamine and dimethylamine, and preferably an alkaline compound.

The neutralizer may be used at 0.1-3.0 equivalents, preferably 0.5-2.0 equivalents, per 1 equivalent of the acid group of the resin with acid groups.

The aggregating agent of the toner core may be a surfactant used in a dispersion, a surfactant having an opposite polarity to the surfactant used in a dispersion or a monovalent or higher inorganic metal salt.

Generally, since the aggregating ability increases as the ionic charge number increases, an appropriate aggregating agent needs to be selected in consideration of the aggregating rate of the dispersion or the stability of the method of preparation. Examples of the monovalent or higher inorganic metal salt are calcium chloride, calcium acetate, barium chloride, magnesium chloride, sodium chloride, sodium sulfate, ammonium sulfate, magnesium sulfate, sodium phosphate, sodium dihydrophosphate, ammonium chloride, cobalt chloride, strontium chloride, cesium chloride, nickel chloride, rubidium chloride, potassium chloride, sodium acetate, ammonium acetate, potassium acetate, sodium benzoate, aluminum chloride and zinc chloride.

The toner prepared by a method according to an embodiment of the present invention may be applied to an electrophotographic image forming device. Here, the electrophotographic image forming device may be a laser printer, a photocopier or a facsimile.

The present invention will be described in further detail with reference to the following examples. These examples are for illustrative purposes only and are not intended to limit the scope of the present invention.

### Examples

Synthesis of Polyester Resin

### Preparation Example 1

### Synthesis of Polyester Resin 1

A 3 L reactor equipped with a stirrer, a nitrogen gas inlet, a thermometer and a cooler was installed in an oil bath in which the oil is a heat transfer medium. A variety of monomer, that is 50 parts by weight of dimethyl terephthalate, 47 parts by weight of dimethyl isophthalate, 80 parts by weight of 1,2-propylene glycol and 3 parts by weight of trimellitic acid were added to the reactor. Then, dibutyl tin oxide was added thereto as a catalyst at a ratio of 500 ppm with respect to the total weight of the monomers. Then, the reaction temperature was increased to 150 while stirring the mixture at a speed of 150 rpm. The reaction was performed for about 6 hours, and then, the reaction temperature was increased to 220. The pressure of the reactor was reduced to 0. 1 torr in order to remove the byproducts, and the reaction was completed after maintaining at the pressure for 15 hours. As a result, polyester resin 1 was obtained.

The glass transition temperature (Tg) of the polyester resin 1 measured using a differential scanning calorimeter (DSC) was 62. In addition, the softening temperature (Ts) of the polyester resin 1 measured using a flow tester CFT-500 was 156. The number average molecular weight and poly dispersity index (PDI) of the polyester resin 1 were measured by a gel permeation chromatography (GPC) using polystyrene as a standard sample and they were respectively 4,300 and 3.5. An acid value measured by titration was 15 mg KOH/g.

### Preparation Example 2

### Synthesis of Polyester Resin 2

Polyester resin 2 was prepared in the same manner as in Preparation Example 1, except that the process of removing byproducts was performed for 10 hours. As a result of measuring Tg of the polyester resin 2 using a DSC after the reaction, the Tg was 66. The Ts of the polyester resin 2 measured using a flow tester CFT-500 was 138. The number average molecular weight and PDI of the polyester resin 2 which were measured by a GPC using polystyrene as a standard sample were respectively 2,100 and 3.4. An acid value measured by titration was 14 mg KOH/g.

Preparation of Coloring Pigment Master Batch

### Preparation Example 3

### Preparation of Black Pigment Master Batch

The polyester resin synthesized in Preparation Example 1 and a carbon black pigment (Degussa GmbH of Germany, NIPEX 150) were mixed at a weight ratio of 8:2. Then, 50 parts by weight of ethyl acetate was added to 100 parts by weight of the polyester resin and the mixture was heated to about 60, and then stirred with a mixer. Then, while the mixture was mixed at a rate of 50 rpm using a biaxial extruder having a vacuum device, ethyl acetate as a solvent was removed using the vacuum device to obtain a black pigment master batch.

Preparation of Toner Particles

### Example 1

60 g of polyester resin synthesized in Preparation Example 1, 40 g of black pigment master batch synthesized in Preparation Example 3, 1 g of a charge control agent (N-23;HB Dinglong Co.), 4 g of paraffin wax, and 150 g of methylethyl ketone as an organic solvent were added to a 1 L reactor equipped with a cooler, a thermometer, and an impeller stirrer. While the mixture was stirred at a rate of 600 rpm, 25 ml of 1N NaOH solution was added thereto. Then, the mixture was mixed at 80 for 5 hours while refluxing. When the mixture has sufficient fluidity, it was further stirred at 500 rpm for 2 hours. As a result, a toner mixture was obtained.

600 g of distilled water, 5 g of a neutral surfactant (Tween 20, Aldrich Co.), and 1 g of sodium dodecyl sulfate (Aldrich Co.) as an anionic surfactant were added to a separate 3 L reactor equipped with a cooler, a thermometer and an impeller stirrer, and the mixture was stirred at 85 at 600 rpm for 1 hour to obtain a dispersion medium.

The toner mixture was added to the dispersion medium and stirred at the same temperature, i.e., 85, at 1000 rpm for 1 hour to prepare a toner micro-suspension.

Then, 145 g of methylethyl ketone as an organic solvent was removed in a partially reduced pressure of 100 mmHg while the reactor was heated to 90. Thus, a toner core dispersed in the dispersion medium was obtained. The size of the toner core in which methylethyl ketone was removed was measured using a Coulter Multisizer (Beckman Coulter Co.), and the volume average particle size was 400 nm.

Then, the temperature in the reactor was cooled to 80, and 30 g of styrene monomer, 4 g of n-butyl methacrylate and 2 g of methacrylic acid as monomers for polymerization were gradually added to the reactor for 20 minutes. 0.2 g of potassium persurfate dissolved in 100 ml of distilled water as a polymerization initiator was added thereto for 1 hour while the mixture was stirred at 1000 rpm, and the reactor was further stirred at 80 for 4 hours. As a result, a toner composite having a core-shell structure was obtained. The size of the toner composite was measured using a Coulter Multisizer (Beckman Coulter Co.), and the volume average particle size was 450 nm.

Subsequently, 10 g of magnesium chloride dissolved in 50 g of distilled water was gradually added to the reactor, and the reactor was heated to 80 for 30 minutes to aggregate the toner composite. After 5 hours, the size of the aggregated toner composite was measured using a Coulter Multisizer (Beckman Coulter Co.), and the volume average particle size was 6.7 μm.

Then, melt-adhesion was performed at 80 for 8 hours by adding 500 g of distilled water to the reactor, and the reactor was cooled.

Then, the melt-adhered toner composite, i.e., toner particles, were separated using a filter that is commonly used in the art, washed with 1 N hydrochloric acid solution, and washed again 5 times with distilled water to completely remove a surfactant, and the like. The washed toner particles were dried in a fluidized bed dryer at 40 for 5 hours to obtain dried toner particles.

As a result of analyzing the toner particles, the obtained toner particles had a volume average particle size of 6.8 μm and a 80% span value of 0.65. In addition, as a result of analyzing 100 random toner particle samples by Image J software using a scanning electron microscope (SEM; JEOL Ltd.), a mean shape factor was 0.69.

### Example 2

Toner particles were prepared in the same manner as in Example 1, except that polyester resin 2 synthesized in Preparation Example 2 was used.

As a result of analyzing the toner particles, the obtained toner particles had a volume average particle size of 6.5 μm and a 80% span value of 0.69. In addition, as a result of analyzing 100 random toner particle samples by Image J software using a scanning electron microscope (SEM; JEOL Ltd.), a mean shape factor was 0.71.

### Comparative Example 1

Toner particles were prepared in the same manner as in Example 1, except that seed-polymerization is omitted after forming the toner micro-suspension.

As a result of analyzing the toner particles, the obtained toner particles had a volume average particle size of 6.5 μm and a 80% span value of 0.65. In addition, as a result of analyzing 100 random toner particle samples by Image J software using a scanning electron microscope (SEM; JEOL Ltd.), a mean shape factor was 0.65.

### Comparative Example 2

Toner particles were prepared in the same manner as in Example 1, except that polyester resin 2 synthesized in Preparation Example 2 was used and seed-polymerization is omitted after forming the toner micro-suspension.

As a result of analyzing the toner particles, the obtained toner particles had a volume average particle size of 6.3 μm and a 80% span value of 0.68. In addition, as a result of analyzing 100 random toner particle samples by Image J software using a scanning electron microscope (SEM; JEOL Ltd.), a mean shape factor was 0.69.

Volume average particles sizes of the toner according to Examples 1 and 2 and Comparative Examples 1 and 2 were measured using a Coulter Multisizer 3. An aperture of 100 μm was used in the Coulter Multisizer, an appropriate amount of a surfactant was added to 50 to 100 ml of ISOTON-II(Beckman Coulter Co.) as an electrolyte, and 10 to 20 mg of a sample to be measured was added thereto, and the resultant was dispersed in a ultrasonic dispersing apparatus for 1 minute to prepare a sample for the Coulter Multisizer.

In addition, the 80% span value which is an index that determines the particle size distribution was calculated by Equation 1 below. The volume of toner particles is accumulated from particles of the smallest size in ascending order until the accumulated volume reaches 10% of the total volume of the toner. An average particle size of the accumulated particles is defined as d10. Average particle sizes of the accumulated particles corresponding to 50% and 90% of the total volume of the toner are respectively defined as d50 and d90.

80% span value=(d90−d10)/d50 Equation 1

Here, a smaller span value indicates a narrow particle distribution, and a larger span value indicates a wide particle distribution.

In addition, the shape factor was calculated by Equation 2 below by measuring SEM images (×1,500) of 100 random toner particles and analyzing them using Image J software.

Shape factor=4π(area/perimeter̂2) Equation 2

Here, the area indicates an projected area of the toner and the perimeter indicates a projected circumference of the toner. The shape factor may be in the range of 0 to 1, the closer the value is to 1, the more spheric the shape is.

Meanwhile, a method of evaluating resins is as follows.

Using a differential scanning calorimeter (Netzsch Co.), the temperature of a sample was increased from 20 to 200 at 10/min, rapidly cooled to 10 at 20/min, and heated at 10/min to measure a glass transition temperature (Tg). The median of each tangent with a baseline near the endothermic curve obtained was defined as Tg.

A softening temperature (Ts) was measured using a flow tester CFT-500 (Shimadzu Co.), and a temperature at which a half of 1.5 g of a sample flow out through a nozzle having a diameter of 1.0 mm and a length of 10 mm in a 10 Kgf load at 6/min was defined as Ts.

The acid value (mg KOH/g) was measured by dissolving the resin in a dichloromethane, cooling the solution and titrating the solution with 0.1N KOH methyl alcohol solution.

According to the method, the toner particles are prepared by including all of the toner components in the preparation of the micro-suspension, and thus additional process for preparing a dispersion may be omitted. In addition, charge properties of the toner may be improved by suppressing exposure of the coloring agent on the surface of the toner particles using the coloring pigment master batch.

Toner particles prepared according to Examples 1 and 2 and Comparative Examples 1 and 2 were evaluated as follows.

Storage Stability at a High Temperature

10 g of toner, 0.2 g of silica (TG 810G, Cabot co.) and 0.05 g of silica (RX50, Degussa GmbH) were mixed to prepare 10.25 g of a toner with external additives. Then, the toner with external additives was charged into a 25 ml glass bottle and placed at 50 and 80% humidity for 72 hours. Storage stability at a high temperature was evaluated by observing the toner with external additives with eyes. The results are summarized in Table 1 as ∘, Δ, ×, which indicates properties as follows.
∘: No flocculation, thus no problem.
Δ: weak flocculation but flocculated particles are scattered when shaking, no substantial problem.
×: strong flocculation and not scattered, substantial problem.

Fixing Temperature Range: Resistance to Hot Offset

100 g of toner, 2 g of silica (TG 810G; Cabot Co.) and 0.5 g of silica (RX50, Degussa GmbH) were mixed to prepare a toner with external additives. Using the toner with external additives, unfixed solid images of 30 mm×40 mm were prepared by a Samsung CLP-510 printer. Then, the fixing properties of the unfixed images were evaluated while varying the temperature of a fixing roller at a fixing tester in which the fixing temperature could be controlled.

Charge Stability against Environment Changes

0.2 g of each of the toner placed under three environmental conditions (temperature/humidity) as follows for 16 hours and 2 g of carriers were mixed at 150 rpm for 15 minutes. Then, a blow off charge amount (Vertex Co.) was measured by a common method of measuring charge amount of binary toner.
1) 10/10% 2) 25/55% 3) 32/80%

The results are shown in Table 1.

TABLE 1
Evaluation of toner performance

| | Storage | | | | |
|---|---|---|---|---|---|
| | stability | Fixing | Charge stability against | | |
| | at a high | temperature | environment changes (uC/g) | | |
| | temperature | range ( ) | 10/10% | 25/55% | 32/80% |
| Example 1 | ∘ | 170-210 | −23.5 | −23.4 | −22.4 |
| Example 2 | ∘ | 140-200 | −24.8 | −26.1 | −25.5 |
| Comparative | | 140-190 | −24.5 | −25.4 | −17.4 |
| Example 1 | | | | | |
| Comparative | x | 130-160 | −24.1 | −23.2 | −16.9 |
| Example 2 | | | | | |

Referring to Table 1, storage stability at a high temperature of the toner prepared in Examples 1 and 2 was better than that of Comparative Examples 1 and 2. In addition, the fixing temperature range of the toner prepared in Examples 1 and 2 was 140-210, and the fixing temperature range of the toner of Comparative Examples 1 and 2 was 130-190. Accordingly, it can be seen the fixing temperature range of the toner of Examples 1 and 2 is higher than that of Comparative Examples 1 and 2. Thus, the occurrence of hot offset may be reduced in the toner of Examples 1 and 2 compared to the toner of Comparative Examples 1 and 2. Furthermore, with regard to charge stability against environment changes, while the charge amount of the toner of Examples 1 and 2 (−23.5˜−24.8→−23.4˜−26.1→−22.4˜−25.5) varies narrowly as the temperature and humidity increase, but the charge amount of the toner of Comparative Examples 1 and 2 (31 24.1˜−24.5→−23.2˜−25.4→−16.9˜−17.4) varies widely. Thus, it can be seen that charge stability against environment changes of the toner of Examples 1 and 2 is more excellent than that of Comparative Examples 1 and 2.

As described above, since the toner according to the present invention is formed of core particles including a polyester resin and a shell including a styrene-acrylic resin, the toner can have both advantages of the polyester resin having excellent anti-hot offset properties and the styrene-acrylic resin having excellent storage stability at a high temperature.

1. A method of preparing a toner, the method comprising:
preparing a mixture by mixing a resin with acid groups, a coloring agent and at least one additive with an organic solvent, and neutralizing the acid groups of the resin with a base;
forming a micro-suspension by adding the mixture to a dispersion medium;
forming a toner core by removing the organic solvent from the micro-suspension; and
forming a toner composite having a core-shell structure by seed-polymerizing at least one monomer on the surface of the toner core.

2. The method of claim 1, wherein the resin with acid groups is a polyester resin having a number average molecular weight of 2,000-10,000, a poly dispersity index (PDI) of 2-15, a THF insoluble content of 1 wt % or less, and an acid value of 5-100 mgKOH/g.

3. The method of claim 2, wherein an acid value of the polyester resin is 7-30 mgKOH/g.

4. The method of claim 1, wherein the coloring agent is in the form of a coloring pigment master batch wherein the amount of the coloring pigment in the master batch is in the range of 10 to 60 parts by weight based on 100 parts by weight of the master batch.

5. The method of claim 1, further comprising: aggregating the seed-polymerized toner composite; melt-adhering the aggregated toner composite; and forming toner particles by washing and drying the melt-adhered toner composite, after forming the toner composite.

6. The method of claim 1, wherein the resin with acid groups comprises at least one selected from the group consisting of a carboxyl group, a phosphoric acid group and a sulfonic acid group.

7. The method of claim 1, wherein the additive comprises a charge control agent or a releasing agent.

8. The method of claim 1, wherein the dispersion medium comprises a polar solvent, a surfactant, a thickener, or a mixture thereof.

9. The method of claim 1, wherein the monomer used in the seed-polymerization comprises at least one selected from the group consisting of styrene, n-butyl methacrylate, methacrylic acid, acrylic acid, divinyl benzene and methacrylate.

10. The method of claim 1, wherein a polymerization initiator used in the seed-polymerization comprises at least one selected from the group consisting of potassium persulfate, ammonium persulfate, benzoyl peroxide, lauryl peroxide, sodium persulfate, hydrogen peroxide, t-butyl hydroperoxide, cumene hydroperoxide, p-methane peroxysalt and peroxy carbonate.

11. A toner prepared according to the method of claim 1, and having a volume average particle size of 2.0-10.0 μm, a 80% span value of 0.9 or less and a shape factor of 0.6-1.0.

12. An electrophotographic image forming device using the toner according to claim 11.
